(19) United States
(12) Patent Application Publication
(10) Pub. No.: US 2021/0229174 A1
(43) Pub. Date: Jul. 29, 2021

(54) BINDER COMPOSITION FOR METAL INJECTION MOLDING FEEDSTOCKS; METAL INJECTION MOLDING FEEDSTOCK COMPRISING THE SAME; METAL INJECTION MOLDING PROCESS USING THE FEEDSTOCK, AND ARTICLE OBTAINED BY THE PROCESS

(71) Applicant: HÖGANÄS AB, Höganäs (SE)

(72) Inventors: Åsa Ahlin, Höganäs (SE); Eva Lundin, Ödåkra (SE); Anna Ahlquist, Höganäs (SE)

(21) Appl. No.: 17/053,341

(22) PCT Filed: May 10, 2019
(86) PCT No.: PCT/EP2019/062018

§ 371 Date: Nov. 5, 2020

(30) Foreign Application Priority Data
May 15, 2018 (EP) 18172335.4

(51) Int. Cl. B22F 3/10; B22F 3/22; C08L 71/02; B22F 1/00

(52) U.S. Cl. CPC B22F 3/1021; B22F 3/225; C08L 71/02; B22F 1/0011; B22F 2001/0066; B22F 2301/35; B22F 2301/10; B22F 2304/10; B22F 1/0059

(57) ABSTRACT

The present invention relates to a feedstock for a Injection Molding Process, consisting of sinterable particles P made from a metal, a metal alloy, a cermet, a ceramic material, a glass, or a mixture of any of these; and a binder composition B, the binder composition B comprising a binder polymer B1, a polymeric compatibilizer B2, and optionally a release agent B3, and a MIM manufacturing process using the same.

### FIELD OF THE INVENTION

The present invention concerns a binder composition for Metal Injection Molding (MIM), a MIM feedstock comprising the binder composition, the use of the MIM feedstock in a Metal Injection Molding process, a MIM process using the feedstock, and articles obtainable from the MIM Process or by using the MIM feedstock.

### BACKGROUND OF THE INVENTION

Metal Injection Molding (MIM) is a technique by which it is possible to produce sintered articles of complex shapes from MIM feedstocks comprising sinterable (typically metal) particles and a binder composition. During the MIM process, the MIM feedstock comprising the sinterable particles and the binder composition is formed into the desired shape by injection molding, forming a so-called “green body”. Subsequently the binder composition is removed (e.g. thermally or catalytically) to forming a so-called “brown body”, and the brown body is sintered to fuse the sinterable particles at least a part of their surface. Thereby, a sintered article is obtained. The sintered articles can have a relatively high density, i.e. their apparent density is close to that of the bulk material forming the sinterable particles, showing that the void ratio/porosity of the sintered article is relatively low.

In general, small particle carbonyl iron powders are used in such a process. It is also common to use other types of powders, such as gas atomized and water atomized steel or metal powders of very fine particle size. However, the cost of these fine powders is relatively high, making the process economically unfavorable.

In order to improve the competitiveness of the MIM process it is desirable to reduce the cost of the powder used. One way of achieving this is involves the use of cheaper, coarser powders. However, coarse powders have a lower surface energy than fine powders and are thus much less active during sintering, thereby increasing the risk of structural defects in the sintered object. Another issue is that coarser and irregular powders have a lower packing density, and thus the maximal powder content of the feedstock is limited. This increases costs for the binder phase due to its relatively higher content, and may also lead to problems during extrusion. A lower powder content also results in a higher shrinkage during sintering and may lead to unacceptable dimensional variations between components produced in a production run.

In many ways, the binder composition (or short “binder”) is a very important part of the entire process, and it has to fulfill several criteria. The binder must be able to incorporate a high volume of sinterable particles (e.g. fine metal, metal alloy or ceramic powders), typically 60% by volume or more. It must also be able to form a coherent mass that can be plastified and injection molded at elevated temperature. Further, removal of the main binder constituents must be possible in a reasonably short, environmentally friendly process. The binder further must provide enough strength after debinding by means of the ‘backbone binder’. It should be supplied in a form that can easily be fed into an injection moulding machine, e.g. in a regular granular shape, and should have consistent, uniform properties from batch to batch. The development of MIM technology was to a great extent the development of binder compositions and the corresponding debinding technologies.

The development can be traced from the late 1970's when the potential of Raymond Wiech's basic invention of the MIM process was recognized to the beginning of the 1990's when the industrialization of the technology began.

Many different types of binders are used in MIM processes. There are at least four general types of binders used in MIM, most of which are polymers, being characterized as follows: thermoplastic compounds, thermosetting compounds, water based systems, and inorganics.

Yet, all of these suffer from various drawbacks. These include, but are not limited to, segregation between the various materials in the feedstock, low melt flow index causing problems in the injection molding process, inability to form a continuous coherent phase essentially containing no voids, and/or difficulties in using coarse metal powder. Another drawback of prior art binders may be that it is difficult to manufacture large components due to insufficient strength or coherence of the binder phase.

There is still a need for binder compositions not having any or exhibiting fewer of the drawbacks mentioned above, or to a lesser extent.

### OBJECTS OF THE INVENTION

One object of the invention is to provide a binder composition, for a metal injection molding feedstock, having the following properties and/or advantages.

It is one object of the present invention to provide a new composition suitable for use in a MIM process.

One object of the present invention is to provide a binder composition for a MIM feedstock that is able to incorporate larger, and hence cheaper, sinterable particles.

It is another object of the invention to provide a binder composition for a MIM feedstock that is able to form a coherent phase essentially free of voids in a metal injection molding process, and which is also able to manufacture large parts without structural failure.

It is a further object of the present invention to provide a binder composition for a MIM feedstock in which large amounts of relatively large sinterable particles can be stably dispersed and/or which provides good flowability to the feedstock.

It is another object of the present invention to provide a binder for a MIM feedstock that is able to provide a brown body having sufficient strength to be handled without collapse of the structure.

It is yet a further object of the present invention to provide an article prepared by a MIM process, which article is superior to prior art articles in terms of density (absence of voids), absence or reduction of segregations and/or manufacturing costs.

### SUMMARY OF THE INVENTION

It has now been found that by careful selection of binder composition components, a new binder for feedstocks for metal injection molding is obtained that improves not only the feedstock properties such as, but also improves results from injection molding.

The present invention thereby solves one or more of the above aspects by the following:
1. Feedstock for an Injection Molding Process, consisting of
   sinterable particles P made from a metal, a metal alloy, a cermet, a ceramic material, a glass, or a mixture of any of these; and

a binder composition B, the binder composition B comprising
a binder polymer B1,
a polymeric compatibilizer B2, and
optionally a release agent B3.
2. Feedstock according to item 1, wherein the binder polymer B1 is one or more polymers selected from the group consisting of polyoxymethylene homopolymers, polyoxymethylene copolymers, polyoxyethylene homopolymers, polyoxyethylene copolymers, polyethylene homopolymers, polyethylene copolymers, polypropylene homopolymers, and polypropylene copolymers, and is preferably one or more polymers selected from the group consisting of polyoxymethylene homopolymers, polyoxymethylene copolymers, polyoxyethylene homopolymers, and polyoxyethylene copolymers.
3. Feedstock according to any one of items 1 and 2, wherein the binder polymeric compatibilizer is a thermoplastic polymer that has or that is modified such as to have at least one functional group capable of interacting with the surface of the sinterable particles.
4. Feedstock according to item 3, wherein the modification of the thermoplastic polymers is effected by a graft modification.
5. Feedstock according to any one of items 3 and 4, wherein the functional group capable of interacting with the surface of the metal particles is selected from a hydroxyl group, an ether group, an oxo group, an ester group, a carboxylic acid group, a carboxylic acid anhydride group, a thiol group, an amide group, an urethane group, an ureido group and a silane group.
6. Feedstock according to any one of items 1 to 5, wherein the amount of the polymeric compatibilizer B2 is from 5 to 25% by weight, relative to the total weight of the binder composition B.
7. Feedstock according to any one of items 1 to 6, wherein the optional release agent is present, and is preferably present in an amount of 1-10% by weight, relative to the total of the binder composition B.
8. Feedstock according to any one of items 1 to 7, wherein the release agent is selected from carboxylic acid amides, alkylene-bis-amides such as ethylene bis-stearamide, alpha-olefin waxes having a melting point of 150° C. or less according to ASTM D-127, preferably selected from polyethylene waxes and polypropylene waxes, alcohols, preferably those having 8 to 30 carbon atoms, carboxylic acids, preferably those having 8 to 30 carbon atoms such as stearic acid or behenic acid, carboxylic acid esters, preferably those having 8 to 30 carbon atoms in the moiety originating from a carboxylic acid and 1 to 10 carbon atoms in the moiety originating from an alcohol, polytetrahydrofuran, oxidized polyethylene, oxidized polypropylene, polycaprolacton, polyethylene glycol, preferably having a weight average molecular weight of 10,000 or less, preferably 5,000 or less, such as 2,500 or less, cellulose, and lactams having 5 to 18 carbon atoms, such as laurolactam.
9. Feedstock according to any one of items 1 to 8, wherein the sinterable particle P is made from a metal or metal alloy, and wherein the sinterable particle is preferably made from a material selected from copper, iron, iron-based alloys and copper-based alloys, and more preferably stainless steel.
10. Feedstock according to any one of items 1 to 9, wherein the weight-average particle diameter of the sinterable particles D50, determined by a laser light scattering method, is between 5 and 50 μm, between 20 and 50 μm or between 5 and 20 μm.
11. Feedstock according to any one of items 1 to 10, wherein the amount of the binder polymer B1 is from 65 to 95% by weight, preferably from 70 to 95% by weight, more preferred 73 to 95% by weight, the amount of the polymeric compatibilizer B2 is from 5 to 25% by weight, and the amount of release agent B3 is from 0 to 20% by weight, all relative to the total weight of the binder composition B, and wherein preferably the total amount of the binder polymer B1, the polymeric compatibilizer B2 and the optional release agent B3 accounts for 95-100% by weight of the binder composition B.
12. Feedstock according to any one of items 1 to 11, which comprises the sinterable particles P in an amount of 45 to 70% by volume, the remainder being formed by the binder composition B, and/or which has a Melt Flow Rate (MFR) of 250 to 900 g/10 minutes.
13. Feedstock according to items 1-12, which is in the form of a filament or in the form of pellets.
14. Use of the feedstock as defined in any one of items 1 to 13 in a metal injection molding process.
15. Metal Injection Molding Process, comprising the steps

A. Injecting the feedstock as defined in any one of items 1 to 13 into a mold;

B. Removing the injection-molded green body from the mold;

C. Debinding the feedstock to thereby remove essentially all of the binder composition by a catalytic, thermal or chemical treatment, or a combination thereof, to obtain a Brown Body; and

D. Sintering the Brown Body.

Further and preferred aspects of the present invention will become apparent in view of the following detailed description.

### BRIEF DESCRIPTION OF THE DRAWINGS

FIG. 1 is a graphical representation showing the influence of the relative amounts of binder polymer B1, the polymeric compatibilizer B2 and the release agent B3 on the Melt Flow Rate (MFR) of the feedstock based on the results obtained in the Examples; and

FIG. 2 is a graphical representation of the moldability (as evaluated in the Examples) in dependency of the relative amount and nature of binder polymer B1 for the feedstocks evaluated in the Examples.

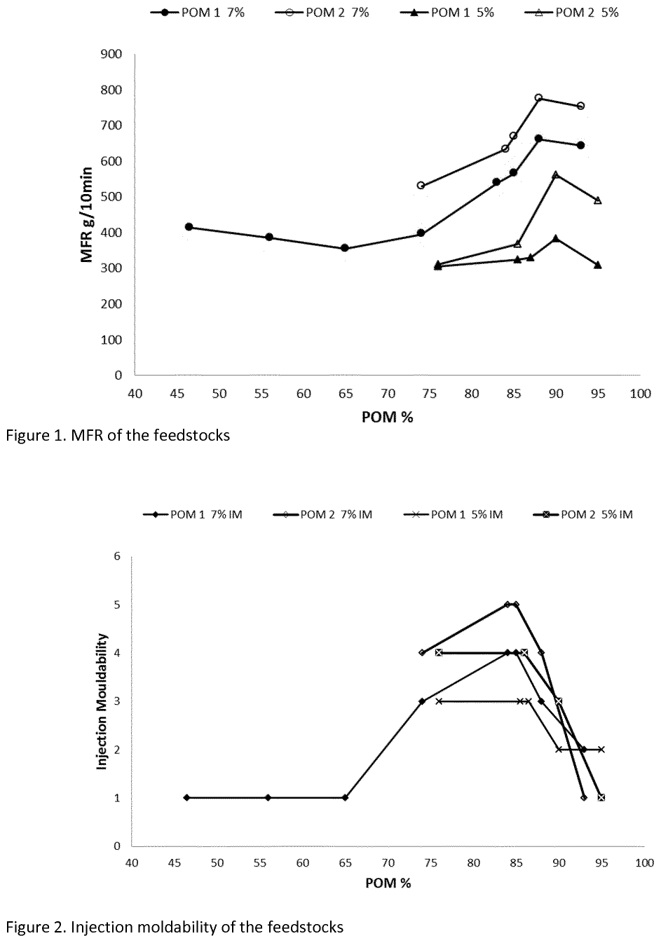

### DEFINITIONS

The following terms and definitions will be used and apply in the following detailed description:

Any given range referred to by a lower and upper limit, such as for example “2 to 5” or “between 2 and 5”, includes the lower and the upper value, as any value in between. Values greater than the lower limit or lower than the upper limit are explicitly included. The term is thus to be understood as abbreviation for the expression “[lower limit] or greater, but [upper limit] or lower”.

Whenever reference is made to ranges and more preferred ranges, the lower and upper limits can be freely combined. As one example, the phrase “5 to 10, preferably 6 to 8” also includes the ranges of 5 to 8 and 6 to 10.

The term “polymer” and “polymeric compound” are used synonymously. A polymer or polymeric compound is generally characterized by comprising 5 or more, typically 10 or more repeating units derived from the same monomeric compound/monomer. A polymer or polymeric material generally has a molecular weight of at least 300, typically 1000 or greater. The polymer may be a homopolymer, a random copolymer or a block copolymer, unless reference is made to specific forms thereof. The polymer may be synthesized by any method known in the art, including radical polymerization, cationic polymerization and anionic polymerization.

A monomer in the sense of the present invention is typically a molecule of a chemical species that is capable to react with another molecule of the same chemical species to form a dimer, which then is able to react with a another molecule of the same chemical species to form a trimer, etc., to ultimately form a chain wherein 5 or more, preferably 10 or more repeating units derived from the same chemical species are connected to form a polymer. The group of the monomer molecule capable of reacting with a group of another monomer molecule to form the polymer chain is not particular limited, and examples include an ethylenically unsaturated group, an epoxy group, etc. The monomer may be monofunctional, bifunctional, trifunctional or of higher functionality. Examples of bifunctional monomers include di(meth)acrylates and compounds possessing both a carboxylic acid group and an amide group, and examples of trifunctional monomers include tri(meth)acrylates.

The term “(meth)acrylic acid” is used to jointly denote methacrylic acid and acrylic acid, and the term “(meth)acrylate” is used to jointly denote esters of methacrylic acid and acrylic acid, such as methyl methacrylate or butyl acrylate. The ester residue is preferably a hydrocarbon group having 1 to 20 carbon atoms, which may or may not have further 1, 2, 3 or more substituents. The substituents are not particularly limited and may be selected from a hydroxyl group, a cyano group, an amino group, an alkoxy group, a alkyleneoxy group, etc. The ester group of the (meth)acrylate is preferably a non-substituted straight or branched alkyl group having 1 to 20, preferably 1 to 12 carbon atoms, or is a straight or branched alkyl group having 1 to 20, preferably 1 to 12 carbon atoms that is substituted with one or two hydroxyl groups.

The term α-olefin denotes hydrocarbon compounds typically having 2 to 10 carbon atoms and having a terminal ethylenically unsaturated group. Examples include ethylene, propylene, 1-butene, 1-propene, styrene, etc. The α-olefin is preferably aliphatic, and is more preferably selected from ethylene and propylene. Preferred examples of polymers of α-olefins thus include polyethylene (which includes the classes of e.g. HDPE, LLDPE and LDPE) and polypropylene (which includes atactic and syndiotactic PP), as well as copolymers of ethylene and propylene.

The term “Tg” denotes the glass transition temperature, measured by Differential Scanning Calorimetry (DSC) according to ASTM D7426-08(2013).

The term “Melt Flow Rate” (MFR) denotes the value obtained according to ISO 1133, using the method described in the Examples section unless specified differently.

In the present invention, all physical parameters are measured at room temperature (20° C.) and at atmospheric pressure (10⁵ Pa), unless indicated differently or prescribed differently by a standard such as ISO or ASTM. In case there should be a discrepancy between a standard method and the methods described and referred to in the following description, the present description prevails.

The term “sinterable” is used to denote inorganic materials that have a melting point of 450° C. or higher, preferably 500° C. or higher, more preferably 600° C. or higher, and still further preferably 700° C. or higher. Sinterable materials in this sense include metals, alloys, ceramics, and glasses having the required melting point. For composites (such as cermet), it would be sufficient if at least some of the material present on the outside of the particle has a melting temperature in the above range, so that the particles may bind to each other during the sintering treatment to form the final sintered body.

As used herein, the indefinite article “a” indicates one as well as more than one and does not necessarily limit its reference noun to the singular.

The term “about” means that the amount or value in question may be the specific value designated or some other value in its neighborhood, generally within a range of ±5% of the indicated value. As such, for instance the phrase “about 100” denotes a range of 100±5, and the phrase “about 60” denotes a range of 60±3.

The term and/or means that either all or only one of the elements indicated is present. For instance, “a and/or b” denotes “only a”, or “only b”, or “a and b together”. In the case of “only a” the term also covers the possibility that b is absent, i.e. “only a, but not b”.

The term “comprising” as used herein is intended to be non-exclusive and open-ended. A composition comprising certain components thus may comprise other components besides the ones listed. However, the term also includes the more restrictive meanings “consisting of” and “consisting essentially of”. The term “consisting essentially of” allows for the presence of up to and including 10 weight %, preferably up to and including 5% of materials other than those listed for the respective composition, which other materials may also be completely absent. In the latter case, the composition “consists of” the recited components.

The term “feedstock” is used to denote a material that can be used for forming a green body by an injection molding operation. The feedstock may have any form or shape, but is preferably in the form of a filament or pellet. The term “filament” denotes a material having a circular, oval, or angular shape when viewed in a cross-section in a direction perpendicular to its longest axis, and wherein the diameter of this circular shape or the longest axis of the oval or angular shape is, by a factor of 10 or more, smaller than the longest axis of the material ([longest axis]/[diameter or longest axis in cross-section perpendicular to longest axis]≥10). The term “pellet” denotes a particle having a circular, oval, or angular shape when viewed in a cross section in a direction perpendicular to its longest axis, and wherein the diameter of the circular shape or the longest axis of the oval or angular shape is, by a factor of less than 10, preferably 5 or less, more preferably 3 or less, further preferably 2 or less, smaller than the longest axis of material ([longest axis]/[diameter or longest axis in cross-section perpendicular to longest axis]<10). The pellet may also be of spherical shape.

Feedstock

The invention is in one aspect directed to a feedstock comprising the binder composition B and sinterable particles P. The feedstock may contain additional components, yet typically essentially consists of or consists of the binder composition B and the sinterable particles P.

Sinterable Particles P

The feedstock of the present invention contains sinterable particles P that, after formation of the green body by injection molding, removal of the binder composition (debinding) from the green body to form a brown body, and sintering treatment to fuse the particles P, form the final 3-dimensional object.

The sinterable particles are made of a metal, metal alloy, glass, ceramic material or a mixture thereof. Herein, “made of” describes that the particles consist of or essentially consist of the metal, metal alloy, glass, ceramic material, or a mixture of these components. Unavoidable impurities may however be present. As such, 95% by weight or more of the sinterable particles consist of a metal, metal alloy, glass, ceramic material, or a mixture thereof, with the remainder being unavoidable impurities. Preferably, at least 98% by weight or more, and more preferable at least 99% by weight or more of the sinterable particles is formed by the metal, metal alloy, glass, ceramic material or a mixture thereof.

The metal that may be comprised in the sinterable particles is not particularly limited, and generally any desirable metal can be used as long as it has the required melting point. The metal should also be processable and should thus not be a reactive species such as sodium or lithium, and should also not be a liquid at ordinary temperatures, such as mercury. Examples of metals that can be used in the present invention include aluminum, titanium, chromium, vanadium, cobalt, iron, copper, nickel, cobalt, tin, bismuth, molybdenum and zinc as well as tungsten, osmium, iridium, platinum, rhenium, gold and silver. Preferred are metal particles of aluminum, iron, copper, nickel, zinc, gold and silver. Since titanium has the general tendency to oxidize or form other chemical species (e.g. nitrides) during the subsequent debinding and sintering steps unless specific steps for avoiding such a reaction are taken (e.g. low debinding or sintering temperature), in one embodiment the sinterable particles are not made from titanium or a titanium alloy. Since iron in non-alloyed form has pure oxidation resistance under certain conditions, the sinterable particles are in one embodiment not made from iron.

The metal alloy also is not further limited, and generally all kinds of metal alloys can be used as long as they have the required melting point, so that do not melt at the debinding temperature, but fuse at the sintering temperature employed during the manufacturing process. Preferred alloys are those formed by aluminum, vanadium, chromium, nickel, molybdenum, titanium, iron, copper, gold and silver as well as all kinds of steel. In the steel, the amount of carbon is generally between 0 and 2.06% by weight, between 0 to 20% of chromium, between 0 and 15% of nickel, and optionally up to 5% of molybdenum. The sinterable particles are preferably selected from metals, iron alloys, stainless steel and ceramics, with stainless steel being particularly preferred.

The glass of which the sinterable particles may be formed is not limited, and all types of glass can be used provided that the glass particles fuse at their boundaries at the sintering temperature employed in the process.

The ceramic material also is not limited, as long as its temperature properties allow fusion of the particles at the sintering temperature. Typically, the ceramic materials include alumina, titania, zirconia, metal carbides, metal borides, metal nitrides, metal silicides, metal oxides and ceramic materials formed from clay or clay type sources. Other examples include barium titanate, boron nitride, lead zirconate or lead titanate, silicate aluminum oxynitride, silica carbide, silica nitride, magnesium silicate and titanium carbide.

The mixtures of the sinterable particle include mixtures of different metals and/or different alloys, but also include mixtures of more different types of materials. An example is a mixture of a metal or metal alloy and a ceramic material, such as a cermet material. For instance, a cermet made of tungsten carbide and cobalt, as used in cutting tools, is also encompassed by the sinterable particles.

The metal or metal alloy forming the sinterable particles may be magnetic or non-magnetic.

The sinterable particles may be of any shape, but non-spherical particles are preferable. This is due to the fact that non-spherical particles provide interlocking regions during the subsequent debinding and sintering steps, which in turn facilitates maintaining a stable form during the debinding and sintering steps.

The particle size (D50) of the sinterable particles is not particular limited, but is preferably 100 μm or less, more preferably 75 μm or less, most preferably 50 μm or less. The particle size can thus be from 5 to 50 μm, and is preferably from 25 to 40 μm. In one embodiment, the present invention makes use of fine particles having a particle size D50 from 5 to 16 or 17 μm, or from 5 to 20 μm. In another embodiment, the present invention makes use of coarse particles having a particle size of 20 to 50 μm, from 25 to 50 μm or from 27 or 28 to 50 μm.

Herein, the particle size relates to the equivalent spherical diameter determined by a laser light scattering technique, measured e.g. with laser emitting at 690 nm, for instance according to ASTM 4464-15, expressed as D50 (50% by weight of the particles have a size of less than the expressed value). An apparatus for determining the particle size that can be used in accordance with the present invention is a SALD-3101 Laser Diffraction Particle Size Analyzer with standard sampler and flow cell SALD-MS30, available from Shimadzu Corporation. It goes without saying that sufficiently many particles must be analyzed in order to obtain a valid result. This is case when the obtained value remains essentially constant (within +/−2%) even when subjecting further particles to the analysis. This is generally achieved once 300 or more, such as 500 or more or 1000 or more particles have been analyzed.

Preferably, most (90% by weight or more) and more preferably all (100% by weight) of the particles have an equivalent spherical diameter equal to or smaller than 100 μm or less, more preferably 50 μm or less. Such particles can be obtained by a suitable operation for removing too large particles, e.g. by sieving.

There is no limitation on the amount of very fine particles, but typically particles having a particle size of 0.1 μm or less, preferably 1 μm or less, still further preferably 3 μm or less, make up 10% by weight or less of the particles P, preferably 5% by weight or less.

In one embodiment, the value of D99 (denoting that 99% by weight of the particles have a particle diameter below the indicated value) is 120 μm or less, preferably 100 μm or less. This applies in particular in combination with the D50 values indicated above.

The above particle sizes relate to the equivalent spherical diameter. However, the actual shape of the particle is not limited to spherical particles, and in some embodiments non-spherical particles may be used. The non-spherical particles may be of regular shape (such as oval or cubic) or of irregular shape, and, without wishing to be bound by theory, it is believed that irregularly shapes particles can be beneficial for obtaining a brown body and/or final object having a higher strength due to an interlocking of the particles.

For all the particle sizes above, a value obtained by volume can be converted into the respective value by weight by simple calculation employing the known density of the material forming the sinterable particles P.

The amount of the sinterable particles is preferably such as to form a solid loading (SL), expressed as [Volume of sinterable particles P]/[total volume of the feedstock]×100, of 30 to 70, more preferably 40 to 60, such as 50 or more to 55 or less. The solid loading is equivalent to the volume percentage of the sinterable particles relative to the total volume of the feedstock.

Binder Composition B

The binder composition forms the other essential component of the feedstock besides the sinterable particles P. The binder composition serves to disperse the sinterable particles, and to form a coherent mass suitable for an injection molding operation. The feedstock may consist of or may essentially consist of the sinterable particles P and the binder composition B.

The binder composition B contains as essential components a binder polymer B1 and a polymeric compatibilizer B2, and may optionally contain a release agent B3. The binder composition may essentially consist of or may consist of B1, B2 and optionally B3, but may also contain one or more additional additives B4, as will be described later.

Binder Polymer B1

The binder polymer B1 forms the bulk of the binder composition and is the component that is mainly responsible for the formation of a cohesive mass in which the sinterable particles P are dispersed.

The amount of the binder polymer is thus generally 50% by weight or more of the binder composition, and is preferably from 65 to 95% by weight, preferably from 70 to 95% by weight, more preferred 73 to 95% by weight, relative to the total weight of the binder composition (or relative to the weight obtained by subtracting the weight of the sinterable particles from the total weight of the feedstock).

The chemical nature of the binder polymer B1 is not particularly limited, and it can be freely chosen from organic polymers that are known as binder components in MIM feedstock compositions. The binder polymer B1 must be removable after the injection molding step, and this removal (also referred to as debinding) can be effected thermally, by solvent extraction or catalytically. In a preferred aspect the binder polymer B1 is one or more polymers selected from the group consisting of polyoxymethylene homopolymers, polyoxymethylene copolymers, polyoxyethylene homopolymers, polyoxyethylene copolymers, polyethylene homopolymers, polyethylene copolymers, polypropylene homopolymers, and polypropylene copolymers. Of these, the polyoxymethylene homopolymers, polyoxymethylene copolymers, polyoxyethylene homopolymers and polyoxyethylene copolymers are preferred, and the polyoxymethylene homopolymers and polyoxymethylene copolymers are more preferred. This is due to the fact that these can be easily debinded by using gaseous HNO₃ at elevated temperatures of e.g. 125° C., forming formaldehyde or ethanal.

In the respective copolymers, the amount of the repeating units denoting the copolymer (e.g. oxymethylene units in case of a polyoxymethylene copolymer) is typically 50% by weight or more, preferably 80% by weight or more. Further, the type of comonomer is not particularly limited, but preferable examples of polyoxymethylene and polyoxyethylene copolymers include those wherein the copolymer is derived from one or more selected from the group consisting oxyalkylenes, preferably oxymethylene or oxyethylene, with oxyethylene/oxymethylene copolymers being a preferred example.

Herein, the polyethylene homopolymers, polyethylene copolymers, polypropylene homopolymers, and polypropylene copolymers are preferably non-modified, i.e. a free of a functional group capable of interacting with a surface of the sinterable particles, as will be described below for the polymeric compatibilizer B2. The polyethylene and polypropylene copolymers are more preferably copolymers that consist of repeating units derived from ethylene and/or propylene and optional additional monomers selected from the group consisting of aliphatic hydrocarbon monomers not containing any other element but C and H, alkyl vinyl ethers, and alkylene oxides, such as ethylene oxide.

The preferred binder polymers B1 include polyoxymethylene homopolymers, polyoxymethylene copolymers, polyoxyethylene homopolymers and polyoxyethylene copolymers. Polyoxymethylene homopolymers and polyoxymethylene copolymers are more preferred.

In one embodiment, the binder polymer B1 is not selected from the group consisting of a polymer mixture or polymer alloy, the mixture or alloy comprising at least a first and a second polymer, the Tg of the first polymer being −20° C. or lower and the Tg of the second polymer being 60° C. or higher; one, two or more block copolymers comprising at least a first polymer block and second polymer block, the first polymer block having a Tg in the range of −20° C. or lower and the second polymer block having a Tg of 60° C. or higher; and mixtures of said first and second polymer and said block copolymer.

The choice of the binder polymer should be made in view of the choice of the other materials of the MIM feedstock, and in particular with regard to the achievement of a suitable rheologic behaviour of the entire feedstock allowing extrusion molding to be conducted smoothly. This includes in particular the choice of a suitable amount of binder polymer B1 and the choice of a material having a suitable Melt Flow Rate. The binder polymer B1 has preferably a Melt Flow Rate (MFR, also referred to as Melt Index MI and related to the Melt Volume Rate MVR by the density of the polymer) of 15 or more but 70 or less (expressed as g/10 minutes and measured according to ISO 1133 at 190° C. and a load of 2.16 kg), more preferably 20 to 65, still further preferably 25-60, such as 32 to 58. At the same time, the melting point of the binder polymer B1 (measured according to ISO 11357-1/-3 at 10° C./min) may be chosen to be in the range of 120 to 240° C., preferably 130 to 185° C. Materials satisfying these criteria simultaneously include the polyoxymethylene copolymers Hostaform™ C52021 and C27021 of Celanese or the Polyoxymethylene Copolymers Kocetal K900 and K700 of Kolon Plastics, Inc.

The binder polymer B1 may consist of only polymer, but may also be a mixture or alloy of two or more polymers. In one embodiment, the binder polymer or the binder polymers have a glass transition temperature Tg, as determined by a DSC method, of 20° C. or less, preferably 0° C. or less.

Polymeric Compatibilizer B2

The binder composition comprises as second essential component a polymeric compatibilizer. The polymeric compatibilizer is a component that differs from the binder polymer B1 in its structure in that it is a polymeric compound that has functional groups capable of interacting with the surface of the sinterable particles. Given that the sinterable particles are typically constituted by materials having affinity to oxygen, the functional group present in the polymeric compatibilizer preferably contains an oxygen atom. The polymeric compatibilizer B2 is however different from a polyoxymethylene homopolymer, polyoxymethylene copolymer, polyoxyethylene homopolymer or polyoxyethylene copolymer, as defined above for the binder polymer B1.

The polymeric compatibilizer typically is a thermoplastic polymer that is modified, in particular graft-modified, with a compound having functional groups capable of interacting with the surface of the sinterable particles. Such groups are preferably selected from a hydroxyl group —OH, an ether group —O—, an oxo (carbonyl) group C═O, an ester group —C(O)O—, a carboxylic acid group C(O)OH (which is typically not a carboxylic acid group of a (meth)acrylate), a carboxylic acid anhydride group —C(O)—O—C(O)—, a thio or thiol group, an amide group C(O)N(R1R2) (wherein R1 and R2 are selected from a hydrogen atom and a C1-6 alkyl group), a urethane group, an ureido group and a silane group, typically of the formula—SiR1R2R3 (wherein R1, R2 and R3 are selected from a hydrogen atom and a C1-6 alkyl group). Further preferably, the polymeric compatibilizer is a polymer that is obtainable by modifying a thermoplastic polymer selected from α-olefin homopolymers and copolymers (in particular homopolymers and copolymers of ethylene, propylene, and mixtures and alloys thereof), but the thermoplastic polymer can also be a condensation homopolymer or copolymer, such as polyamide, polyester or polyurethane, specifically polyethylene terephthalate, polybutylene terephthalate, polyethylene naphthalate, polylactic acid, polybutylene napthalate, etc. Furthermore, the polymeric compatibilizer may be a modified phenylene oxide polymer or copolymer, a modified styrenic polymer or copolymer, and modified other general engineering polymers well known to the skilled person. Preferably, the polymeric compatibilizer is a modified polyolefin, such as modified polyethylene, modified polypropylene or modified ethylene/propylene copolymers.

Herein, “modified” denotes that the polymeric compatibilizer is obtainable by reacting the thermoplastic polymer with a reagent in order to introduce one or more functional groups capable of interacting with the surface of the sinterable particles into the polymer main chain and/or side chain. The modification may be achieved by introducing a group comprising a hydroxyl group, an ether group, an oxo group, an ester group (preferably not including an ester group of a (meth)acrylate), a carboxylic acid group other than a carboxylic acid group of (meth)acrylic acid, a carboxylic acid anhydride group, such as a maleic acid anhydride group, a thiol group, a urethane group, an ureido group, an amide group and a silane group into the main chain and/or the side chain of the polymer. Particularly preferable is a modification of a polyolefin (preferably polyethylene or polypropylene, more preferably polypropylene) by a carboxylic acid anhydride, such as obtained by the grafting of maleic anhydride to polypropylene.

The methods for effecting such a modification are well-known to a skilled person, and for instance the grafting of maleic anhydride on polyethylene/polypropylene blends is described in Polymer Testing, Volume 22, Issue 2, April 2003, pages 191 to 195. Furthermore, such polymers are commercially available, e.g. in the Fusabond® P and E series of DuPont™, such as Fusabond® P353. Maleic-anhydride modified polyethylenes and polypropylenes are also available from Clariant in the Licocene™ series of products, such as Licocene™ PP MA 6452, Licocene™ PE MS 431 or Licocene™ PE MA 4221, as well as from Honeywell in the AC-series of products (e.g. A-C™ 907P).

The polymeric compatibilizer is preferably a thermoplastic material having both a melting point (determined according to ASTM D3418) and a Vicat Softening Point (determined according to ASTM D1525) or melting point in the range of 50° C. or higher to 300° C. or less, more preferably 80° C. or higher to 250 or less, further preferably 100° C. or higher to 200° C. or less, still further preferably 120° C. or higher, such as 130° C. or higher, but 200° C. or less. This ensures that the polymeric compatibilizer softens or melts at temperatures used for processing the feedstock. These requirements can also be met by suitable choosing commercial products.

Preferably, the polymeric compatibilizer is not a (meth)acrylic polymer. Incidentally, in the present invention, the term “(meth)acrylic polymer” is used to denote polymers having repeating units obtained from acrylic acid or methacrylic acid, or esters thereof (also referred to as (meth)acrylates). These esters are typically those having a C1-010 linear, cyclic or branched alkyl chain (where C1-010 denotes that the total number of carbon atoms in the ester moiety is from 1 to 10).

The polymeric compatibilizer B2 may consist of only polymer, but may also be a mixture or alloy of two or more polymers.

The polymeric compatibilizer is in one embodiment formed by one or more polymers having a Tg of 20° C. or less, preferably 0° C. or less, as determined by a DSC method. This embodiment can be combined with the use of one or more binder polymers B1 also having a Tg of 20° C. or less, preferably 20° C. or less.

Optional Release Agent B3

The release agent B3 is optional, and hence may or may not be present. The release agent is a compound that differs from the polymeric binder B1 and the polymeric compatibilizer B2, and it serves to improve the releasability of the green body formed by injection molding from the mold.

The release agent is in one embodiment a wax or other material having a semi-solid consistency at room temperature, but which melts and provides lubrication at temperatures of e.g. 80° C. or lower, such as at 100° C. or lower or 120° C. or lower. The melting point and/or VICAT softening temperature of the release agent is hence preferably lower than the melting point and/or VICAT softening temperature of both the binder polymer B1 and the polymeric compatibilizer B2, or has a melting point that is the same or that is higher by 40° C. or less, preferably 30° C. or less as the melting point and/or VICAT softening temperature of both the binder polymer B1 and the polymeric compatibilizer B2. These components B1 and B2 thus typically have melting points or VICAT softening temperatures of 80° C. or higher, preferably 100° C. or higher or 120° C. or higher. The melting points and/or Vicat softening temperatures of the components B1, B2 and the optional component B3 are thus typically different from each.

Preferred embodiments of the release agent are those in the group consisting of carboxylic acid amides, alkylene-bis-amides such as ethylene bis-stearamide, alpha-olefin waxes having a melting point of 160° C. or less according to ASTM D-127, preferably selected from polyethylene waxes and polypropylene waxes, alcohols, preferably those having 8 to 30 carbon atoms, carboxylic acids, preferably those having 8 to 30 carbon atoms such as stearic acid or behenic acid, carboxylic acid esters, preferably those having 8 to 30 carbon atoms in the moiety originating from a carboxylic acid and 1 to 10 carbon atoms in the moiety originating from an alcohol, polytetrahydrofuran, oxidized polyethylene, oxidized polypropylene, polycaprolacton, polyethylene glycol, preferably having a weight average molecular weight of 10,000 or less, more preferably 5,000 or less, such as 2,50 or less, [symbol] , and lactams having 5 to 18 carbon atoms, such as laurolactam. One or more of these release agents can be used.

In one embodiment, the release agent B3 is non-polymeric and has a molecular weight of 3000 or less, preferably 1000 or less, such as 500 or less. Preferred Examples of this embodiment include fatty acids, fatty acid amides and alkylene-bis-amides.

Further Optional Additives B4

The one or more additional optional additives B4 typically forms 10% by weight or less of the binder composition B, but they may also form 5% by weight or 3% by weight of the binder composition. The binder composition may also be free of additional components B4, and then may consist of B1 and B2, or may consist of B1, B2 and B3.

Examples of further optional additives B4 include inorganic or organic substances other than B1, B2 and B3 that are commonly used in MIM feedstocks, such as lubricants, wetting agents, rheology modifiers, coloring agents such as pigments or dyes, or dispersing agents. Notably, the optional additive B4 is not a compound that is encompassed by any of the components B1, B2 or B3.

Relative Amounts of Constituent Components of the Binder Composition

The binder composition includes any components present in the MIM feedstock except for the sinterable particles. The binder composition of the MIM feedstock of the present invention comprises the components B1, B2, optionally B3 and optionally B4.

In one embodiment, the binder composition consists of the binder polymer B1 and the polymeric compatibilizer B2. In another embodiment, the binder composition is formed to 90% by weight or more, preferably 95% by weight or more, more preferably 98% by weight or more (relative to the total weight of the binder composition), or consists of, the binder polymer B1 and the polymeric compatibilizer B2, and, if present, the release agent B3. The binder composition may however also consist of the binder polymer B1, the polymeric compatibilizer B2 and the release agent B3.

The following provides preferred amounts of the components B1, B2, B3 and B4, all in weight % relative to the total weight of the binder composition:

Binder polymer B1: 65 or more, more preferably 70 or more such as 71 or more, further preferably 73 or more, but 95 or less, more preferably 93 or less;

Polymeric Compatibilizer B2: 30 or less, more preferably 25 or less, further preferably 20 or less, still further preferably 15 or less, but 3 or more, more preferably 5 or more, still further preferably 6 or more or 7 or more;

Optional Release Agent B3: 0 or more, more preferably 1 or more, more preferably 3 or more still more preferably 5 or more, but 25 or less, more preferably 15 or less, and still further preferably 12 or less.

Optional Additive B4: 5 or less, more preferably 3 or less, further preferably 2 or less or 1 or less. In one embodiment, the further optional additive B4 is absent. In another embodiment, the amount of the further optional additive B4 is 0.1% by weight or more.

Feedstock Composition and Properties

The feedstock of the present invention essentially consists of the sinterable particles P and the binder composition B. The sinterable particles generally form 45 to 70% by volume of the feedstock, the remainder being formed by the binder composition B. The percentage by weight of the sinterable particles, relative to the weight of the feedstock, is typically a higher numerical value when expressed in percentages, as the density of the sinterable particles is typically higher than the density of the binder composition.

The binder composition forms a coherent continuous phase, and the components thereof are chosen such as to allow a suitable dispersed state of the sinterable particles and allowing the feedstock to be processed by an injection molding technique. This implies in particular a suitable viscosity (as expressed by the melt flow rate, MFR at 190° C. and under a load of 2.16 kg, as described later in the Examples) at elevated temperatures. If the feedstock has a too high viscosity, it will be difficult to process by injection molding and will require strong force or will even block the injection molding apparatus. Yet, if the viscosity is too low, the sinterable particles will settle and accumulate at the bottom part of the injection mold by gravity, and it may also be difficult to obtain a stable dispersed state.

The viscosity/MFR of the feedstock is a result of the overall composition of the feedstock, and in particular of the binder composition B in view of the fact that the particles are typically solids that do not have a noticeable viscosity at the injection molding temperature whereas the binder compositions softens or is a more or less viscous melt a the injection molding temperature. Given that the bulk of the binder composition is typically formed by the binder polymer B1, the selection of material having a suitable viscosity/MFR as binder polymer B1, as outlined above, also enables to adjust the viscosity/MFR of the feedstock such as to obtain a feedstock that is well or excellent to process in an injection molding operation. The viscosity/MFR of the feedstock is of course also influenced by the relative amounts of components of the binder composition B and by their respective viscosities/MFR at the injection molding temperature, as well as by the solid loading/the amount of sinterable particles.

The composition of the feedstock is preferably selected such that the resulting MFR of the feedstock (expressed in g/10 minutes at 190° C. and under a load of 2.16 kg, measured under the conditions outlined in the following Examples) is 100 or higher, more preferably 200 or higher, still further preferably 250 or higher, and even further preferably 300 or higher or 350 or higher, but 1400 or less, more preferably 1200 or less, further preferably 1000 or less or 900 or less, such as 850 or less. The MFR of the feedstock may thus for instance be in the range of 300 to 900, or 350 to 850 g/10 minutes.

The components for the binder polymer B1, the polymeric compatibilizer B2 and the optional release agent B3 and optional further additives B4 can be freely chosen and combined, including combinations of preferred components.

In one aspect of the present invention the polymeric binder B1 is a polyoxymethylene homopolymer or polyoxymethylene copolymer and the polymeric compatibilizer B2 is a carboxylic acid anhydride grafted polypropylene or carboxylic acid anhydride grafted polypropylene/polyethylene copolymer, the carboxylic acid anhydride being preferably maleic acid anhydride. In this embodiment, the optional release agent B3 is preferably present and is further preferably an alkylene bis acid amide such as ethylene bis stearic acid amide.

Metal Injection Molding Process

The metal injection molding process of the present invention comprises the following steps:
A. Injecting the feedstock as described above into a mold;
B. Removing the injection-molded green body from the mold;
C. Debinding the feedstock to thereby remove a part or essentially all of the binder composition by a catalytic, thermal or chemical treatment, or a combination thereof, to obtain a Brown Body; and
D. Sintering the Brown Body.

These steps are as such known to a skilled person, and typical conditions and apparatuses employed in current MIM processes can also be used when practicing the method of present invention.

Once the green body has been formed, it is subjected to debinding and sintering steps. These steps remove the binder composition (debinding treatment) and fuse the sinterable particles P during the sintering process, at least at their boundaries. It results a 3 dimensional object that has a smaller size as compared to the green body.

The step of removing all or essentially of the binder composition is called debinding. This debinding can be achieved in various ways, e.g. by selective removal of the binder composition by solvent treatment (using a suitable solvent such as polar, protic or aprotic solvents, e.g. ethyl acetate, acetone, ethanol, methanol, isopropanol), by treatment with acids such as nitric acid (as liquid, solution or in gaseous form) at elevated temperatures of e.g. 90° C. or higher or preferably 110° C. or higher, catalytically, or thermally.

Preferably, debinding is achieved catalytically, by solvent debinding (solvent extraction of the binder composition) or thermally, and more preferably thermally.

For solvent debinding, it is optionally possible to include a small amount (e.g. 10% or less, or 5% or less by weight of the binder composition) of a polymer backbone material to reduce the risk of collapse of the part prior to sintering. This backbone polymer is not soluble in the solvent used for the binder removal and provides a preliminary support for the part prior to sintering. The backbone polymer is then thermally removed during the sintering step. Suitable backbone polymers are well known in the art, and examples include amongst others LDPE, HDPE, or thermoplastic natural rubbers.

In a thermal debinding step, the green body is put in a furnace and slowly heated for sufficient time, typically in an inert atmosphere or reducing (e.g. hydrogen) atmosphere in order to avoid oxidation of the sinterable particle and/or the binder composition components. The use of an inert or reducing atmosphere is optional and can be omitted, in particular for oxides and ceramics. Conversely, for materials prone to oxidation and in order to avoid a rapid burn-off of the binder components the use of an inert atmosphere or low temperatures may be preferred.

A thermal debinding treatment needs to be performed at a temperature that is sufficient to depolymerize and/or evaporate the polymeric components of the binder composition.

In a catalytic debinding step, the green body is contacted with a catalytically active species, possibly at elevated temperatures. This could for instance be a gaseous acidic environment, e.g. using nitric acid or oxalic acid in a nitrogen atmosphere at about 110-140° C., such as 115-135° C. This is particularly preferably if the binder polymer B1 is a polyoxymethylene or polyoxyethylene homopolymer or copolymer of these, as then gaseous formaldehyde and ethanal are formed which can be readily removed. Yet of course also other catalytically active species and reaction conditions can be chosen by a skilled person based on common knowledge. Generally, the temperature should be below the melting point or VICAT softening temperature of the binder composition.

The entire duration of the debinding step C is generally 2 hours or more, preferably 4 hours or more. The debinding treatment can be performed in an inert atmosphere (such as nitrogen or helium gas), a reducing atmosphere (such as hydrogen gas), or an oxygen containing atmosphere, such as air, possibly also including active species such as gaseous nitric acid or oxalic acid. In the simplest way, the debinding is performed in air. However, some sinterable particles may be prone to oxidation at high temperatures in oxygen-containing atmospheres, and hence for such sinterable particles P a debinding step in an inert atmosphere or a reducing atmosphere may be preferable. This applies for instance to iron particles. Conversely, oxidic species such as alumina or titania or ceramics may be debinded in air.

Subsequently to or continuous with the debinding treatment a sintering treatment is performed. In this step, the brown body obtained after the debinding treatment is sintered in order to connect the outer boundaries of the sinterable particles, e.g. by partial melting.

The temperature during the sintering treatment depends on the material of the sinterable particles and needs to be sufficient in order to cause a partial fusion or coalescence of the particles, but needs to be low enough in order to avoid complete fusion or melting of the particles which will lead to collapse of the 3 dimensional structure. Generally, temperatures in the range of 600 to 1.600° C. are useful, and preferable the temperature of the sintering process includes a maximum temperature of 1.100 to 1.500° C.

The sintering step can be performed in vacuum or an inert atmosphere (such as nitrogen, argon or helium gas), a reducing atmosphere (such as hydrogen). The presence of oxygen in the sintering atmosphere should be avoided in order to avoid oxidation of the sinterable particles, in particular in case the particles are not made from glass or ceramic.

Due to the good flowability and compatibility of the feedstock of the present invention, the obtained sintered article shows no or fewer segregations and/or defects as compared to articles of the prior art prepared by the same process using a prior art MIM feedstock.

### EXAMPLES

The invention is exemplified by the following examples. The invention is however not limited to the following Examples, which are given for illustrative purposes only and are not intended to limit the invention in any way.

### Experimental

The melt flow rate (MFR) of the feedstock was measured in a MI-2 from Göttfört with a capillary diameter of 2,092 mm and length of 8.00 mm. The measurement was performed at 190° C. with 5 min of preheating and a load of 21.6 kg. The MFR value was calculated as a mean of two separate measurements. The sample size was 18 g. The method in all essential aspects is in accordance with ISO 1133.

TS bars and a large debarking component were injection molded in a Battenfield 400-130. The molded parts were measured, weighted and visually inspected. The moulded parts were debinded at 120° C. for 8 hours in HNO₃ (g, 600 ml/h). Sintering was performed at 1375° C. for 1.5 hours in H₂.

The feedstock (binder composition+sinterable particles) was mixed and the contents of the sinterable particles (metal powder) was calculated to be 53.5% by volume, relative to the volume of the feedstock. This corresponds to 87.4 weight %. The metal powder used was stainless steel 174PH having a particle size D50<45 micron. The feedstock was mixed in a continuously production screw mixer at 190° C. and thereafter pelletized.

### Example 1

This Example illustrates how different relative amounts of binder polymer B1 and polymeric compatibilizer influence the MFR, and hence the ability to be used in an injection molding process.

The binder polymer B1 was a Polyoxymethylene (POM 1) available under the tradename Hostaform™ C27021 from Celanese, having a MFR of 39 g/10 minutes and a melting point of 166° C.

The polymeric compatibilizer B2 was maleic anhydride grafted polypropylene polymer (MAH PP), available under the tradename Fusabond™ P353 from DuPont. The melting point is 135° C. The graft efficiency is 1.4 wt.-%.

The release agent B3 was ethylene-bis-stearamide (EBS).

The relative amounts of the components in the binder composition are listed in Table 1. The sintered density of the material of Example 1-6 is given in Table 2.

TABLE 1
Injection moldability and MFR of feedstocks of POM Hostaform
C27021, MAH PP (Fusabond P353) and release agent.

| | | MAH | Release | MFR | |
|---|---|---|---|---|---|
| | POM 1 | grafted | agent | [g/ | Injection |
| Example | [%] | PP [%] | [%] | 10 min] | moldability |
| 1-1 | 46.5 | 46.5 | 7 | 415 | + |
| 1-2 | 56 | 37 | 7 | 387 | + |
| 1-3 | 65 | 28 | 7 | 356 | + |
| 1-4 | 74 | 19 | 7 | 397 | +++ |
| 1-5 | 84 | 9 | 7 | 540 | ++++ |
| 1-6 | 85 | 8 | 7 | 556 | ++++ |
| 1-7 | 88 | 5 | 7 | 662 | +++ |
| Comparative | 93 | 0 | 7 | 643 | ++ |
| Ex. 1-8 | | | | | |
| 1-9 | 76 | 19 | 5 | 305 | +++ |
| 1-10 | 85.5 | 9.5 | 5 | 324 | +++ |
| 1-11 | 90 | 5 | 5 | 382 | ++ |
| Comparative | 95 | 0 | 5 | 308 | + |
| Ex. 1-12 | | | | | |

The evaluation criteria are as follows, and have also been used in the following tests:

+ a lot of segregation and degradation
++ major segregation lines, dull surface finish
+++ minor segregation lines, dull surface finish
++++ no segregation lines, dull surface finish
+++++ no segregation lines, shiny surface finish

All Example and Comparative Example compositions could be successfully employed in a MIM process, despite the high solids loading. Better results as regards moldability could be obtained if the relative amounts of binder polymer B1 and polymeric compatibilizer B2 were adjusted according to the preferred and more preferred embodiments described above. The same applies with respect to MFR. It is also apparent that the amount of release agent has an influence on MFR, and that higher amounts of release agent generally lead to increase of MFR.

TABLE 2
Sintered density of Example 1-6

| Feedstock | Tool | Sintered density |
|---|---|---|
| Batch | factor | (g/cm³) |
| Example | 1.218 | 7.60 |
| 1-6 | | |

Herein, the Tool Factor TF is defined as TF=LF/LE, wherein LE is the length of the tool cavity and LF is the length of the sintered component.

### Example 2

In order to investigate the influence of a change in binder polymer B1, further feedstocks were prepared using the Polyoxymethylene Hostaform C52021 (POM 2), having a melting point of 166° C. and an MFR of 55 g/10 minutes. The same polymeric compatibilizer B2 (maleic anhydride grafted PP (MAH PP), Fusabond P353) and the same release agent B3 (EBS) was used. The respective compositions are shown in Table 3.

TABLE 3
Injection moldability and MFR of feedstocks of POM 2 (Hostaform
C52021), MAH PP (Fusabond P353) and release agent EBS:

| | | MAH | Release | MFR | |
|---|---|---|---|---|---|
| | POM 2 | grafted | agent | [g/ | Injection |
| Example | [%] | PP [%] | [%] | 10 min] | moldability |
| Example 2-1 | 74 | 19 | 7 | 530 | ++++ |
| Example 2-2 | 84 | 9 | 7 | 634 | +++++ |
| Example 2-3 | 85 | 8 | 7 | 669 | +++++ |
| Example 2-4 | 88 | 5 | 7 | 777 | ++++ |
| Comparative | 93 | 0 | 7 | 753 | +++ |
| Example 2-5 | | | | | |
| Example 2-6 | 76 | 19 | 5 | 311 | ++++ |
| Example 2-7 | 85.5 | 9.5 | 5 | 368 | ++++ |
| Example 2-8 | 90 | 5 | 5 | 562 | +++ |
| Comparative | 95 | 0 | 5 | 489 | ++ |
| Example 2-9 | | | | | |

### Example 3

Feedstocks of varying composition including as binder polymer B1 of POM 1 and different types of maleic anhydride grafted PP and PE (MAH PP/PE) were prepared and tested. are presented in Table 4.

Polyoxymethylene was obtained from Ticona GmbH, Sulzbach, Germany and maleic anhydride grafted PP from Du Pont, Clariant and Honeywell. The POM was 88%, the MAH PP/PE was 8% and the release agent was 7%. As release agent, EBS was used.

TABLE 4
MFR of feedstocks of POM 1, different types
of MAH grafted compounds and release agent

| | | MAH grafted | Release | MFR | |
|---|---|---|---|---|---|
| | POM 1 | Compounds | agent | [g/ | Injection |
| Example | [%] | [8%] | [%] | 10 min] | moldability |
| 3-1 | 85 | A-C 1325 P, | 7 | 852 | ++++ |
| | | Honeywell | | | |
| 3-2 | 85 | PPMA 6252GR, | 7 | 955 | ++++ |
| | | Clariant | | | |
| 3-3 | 85 | Fusabond E 528, | 7 | 549 | ++++ |
| | | Du Pont | | | |
| 3-4 | 85 | Fusabond P 353, | 7 | 556 | ++++ |
| | | Du Pont | | | |
| 3-5 | 85 | 596P, Honeywell | 7 | 587 | ++++ |
| 3-6 | 85 | PPMA 7452, | 7 | 259 | ++ |
| | | Clariant | | | |
| 3-7 | 85 | PPMA 6452, | 7 | 251 | ++ |
| | | Clariant | | | |
| 3-8 | 85 | PEMA 4221, | 7 | 1672 | + |
| | | Clariant | | | |
| 3-9 | 85 | PEMA 4351, | 7 | 1462 | + |
| | | Clariant | | | |

The results provided in Table 3 clearly highlight the importance to choose a polymeric compatibilizer that has a suitable MFR such as to lead to a suitable MFR of the overall feedstock.

### Example 4

In this Example, the nature of the binder polymer B1 was varied. The trials of the variation of Polyoxymethylene (POM) Hostaform C27021, Hostaform C52021 from Celanese and Kocetal 900 from Kolon Plastics Inc.

As polymeric compatibilizer B2, maleic anhydride grafted PP (MAH PP) Fusabond P353 from Du Pont was used.

The POM content was 85%, the MAH PP 8% and the release agent EBS 7%. The compositions and the results of the moldability tests are summarized in Table 5:
POM 1 and POM 2 are as outlined above.
POM 3 is the product Kocetal K900 (Polyacetal Copolymer, MFR 42 g/10 minutes, MP 165° C.)
POM 4 is the product Kocetal K700 (Polyacetal Copolymer, MFR 27 g/10 minutes, MP 166° C.)
POM 5 is the product Kocetal K500 (Polyacetal Copolymer, MFR 14 g/10 minutes, MP 166° C.)
POM 6 is the product Kocetal K300 (Polyacetal Copolymer, MFR 9 g/10 minutes, MP 166° C.)
POM 7 is the product Kocetal K100 (Polyacetal Copolymer, MFR 3 g/10 minutes, MP 165° C.)

TABLE 5
MFR of feedstocks of different POM types as binder
polymer B1 (88%), MAH PP (Fusabond P353) as polymeric
compatibilizer B2 and EBS as release agent B3:

| | POM | MAH | Release | MFR | |
|---|---|---|---|---|---|
| | [%] | grafted | agent | (g/ | Injection |
| Example | (85%) | PP [%] | [%] | 10 min) | moldability |
| 4-1 | POM 3 | 8 | 7 | 612 | +++++ |
| 4-2 | POM 2 | 8 | 7 | 690 | +++++ |
| 4-3 | POM 1 | 8 | 7 | 556 | ++++ |
| 4-4 | POM 4 | 8 | 7 | 391 | +++ |
| 4-5 | POM 5 | 8 | 7 | 221 | ++ |
| 4-6 | POM 6 | 8 | 7 | 143 | ++ |
| 4-7 | POM 7 | 8 | 7 | 52 | − (not |
| | | | | | working) |

As is derivable from the above, the choice of a suitable binder B1 having an appropriate MFR allows obtaining a feedstock that is best adapted for a specific MIM process. Notably, the required properties/MFR of the feedstock vary to some extent with the equipment used for the injection molding step (e.g. nozzle diameter) and the process conditions (e.g. injection molding temperature). These parameters can thus be varied and appropriately adjusted by a skilled person by routine activity using the guidance given in the present specification.

### Example 5

To investigate how the metal powder particle size influence the MFR and the injection molding properties a 17-4PH powder from Epson Atmix cooperation was used in this Example. The mean particle size (D50) was measured to 13 μm.

As binder polymer B1 was POM 1 or POM 2 as outlined above. The polymeric compatibilizer B2, maleic anhydride grafted PP (MAH PP) Fusabond P353, and the release agent EBS. The content was 85% POM, 8% MAH PP and 7% release agent, and the solid loading was varied. The compositions and results are presented in Table 6.

TABLE 6
Composition and MFR results.

| | | | Solid | MFR | |
|---|---|---|---|---|---|
| | POM 1 | POM 2 | loading | [g/ | Injection |
| Example | [%] | [%] | [vol. %] | 10 min] | moldability |
| 5-1 | 85 | | 58 | 900 | +++++ |
| 5-2 | 85 | | 60 | 890 | +++++ |
| 5-3 | 85 | | 62 | 900 | +++++ |
| 5-4 | 85 | | 66 | 501 | +++++ |
| 5-5 | 85 | | 70 | 338 | +++++ |
| 5-6 | | 85 | 70 | 394 | +++++ |
| 5-7 | | 85 | 66 | 575 | +++++ |
| 5-8 | | 85 | 62 | 810 | +++++ |

The results show that besides the kind and amount of binder polymer B1 and polymeric compatibilizer B2, also the solid loading has an influence on MFR. The results further show that in the preferred MFR range of the present invention, excellent moldability can be achieved with a variety of solid loadings, and that with the present invention high solid loadings can be realized, in particular with particles having a small diameter while still allowing to obtain a well-processable feedstock (note that the solid loading in Examples 1 to 4 is 53.5 Vol % of the feedstock and that the size of the particles in Examples 1 to 4 is D50<45 micron).

The Examples thus demonstrate that the binder composition of the present invention allows obtaining well-processable feedstocks with particles of different particle diameters and with different solid loadings, and is thus very versatile. It also shows that the feedstock of the present invention can make use of sinterable particles of different sizes, and that any change to the properties caused by a change in the size of the particles can, to a reasonable extent, be compensated for by a proper choice of the components forming the binder composition B and their relative amounts.

1. Feedstock for an Injection Molding Process, consisting of
sinterable particles P made from a metal, a metal alloy, a cermet, a ceramic material, a glass, or a mixture of any of these; and
a binder composition B, the binder composition B comprising a binder polymer B1,
a polymeric compatibilizer B2, and
optionally a release agent B3.

2. Feedstock according to claim 1, wherein the binder polymer B1 is one or more polymers selected from the group consisting of polyoxymethylene homopolymers, polyoxymethylene copolymers, polyoxyethylene homopolymers, polyoxyethylene copolymers, polyethylene homopolymers, polyethylene copolymers, polypropylene homopolymers, and polypropylene copolymers.

3. Feedstock according to claim 1, wherein the binder polymeric compatibilizer is a thermoplastic polymer that has or that is modified such as to have at least one functional group capable of interacting with the surface of the sinterable particles.

4. Feedstock according to claim 3, wherein the modification of the thermoplastic polymers is effected by a graft modification.

5. Feedstock according to claim 3, wherein the functional group capable of interacting with the surface of the metal particles is selected from a hydroxyl group, an ether group, an oxo group, an ester group, a carboxylic acid group, a carboxylic acid anhydride group, a thiol group, an amide group, an urethane group, an ureido group and a silane group.

6. Feedstock according to claim 1, wherein the amount of the polymeric compatibilizer B2 is from 5 to 25% by weight, relative to the total weight of the binder composition B.

7. Feedstock according to claim 1, wherein the optional release agent is present, and is preferably present in an amount of 1-10% by weight, relative to the total of the binder composition B.

8. Feedstock according to claim 1, wherein the release agent is selected from carboxylic acid amides, alkylene-bis-amides such as ethylene bis-stearamide, alpha-olefin waxes having a melting point of 160° C. or less according to ASTM D-127, selected from polyethylene waxes and polypropylene waxes, alcohols, those having 8 to 30 carbon atoms, carboxylic acids, those having 8 to 30 carbon atoms such as stearic acid or behenic acid, carboxylic acid esters, those having 8 to 30 carbon atoms in the moiety originating from a carboxylic acid and 1 to 10 carbon atoms in the moiety originating from an alcohol, polytetrahydrofuran, oxidized polyethylene, oxidized polypropylene, polycaprolacton, polyethylene glycol, having a weight average molecular weight of 10,000 or less, 5,000 or less, such as 2,500 or less, less, and lactams having 5 to 18 carbon atoms, such as laurolactam.

9. Feedstock according to claim 1, wherein the sinterable particle P is made from a metal or metal alloy, and wherein the sinterable particle is made from a material selected from copper, iron, iron-based alloys and copper-based alloys.

10. Feedstock according to claim 1, wherein the weight-average particle diameter of the sinterable particles D50, determined by a laser light scattering method, is between 5 and 50 μm.

11. Feedstock according to claim 1, wherein the amount of the binder polymer B1 is from 65 to 95% by weight, the amount of the polymeric compatibilizer B2 is from 5 to 25% by weight, and the amount of release agent B3 is from 0 to 20% by weight, all relative to the total weight of the binder composition B, and wherein the total amount of the binder polymer B1, the polymeric compatibilizer B2 and the optional release agent B3 accounts for 95-100% by weight of the binder composition B.

12. Feedstock according to claim 1, which comprises the sinterable particles P in an amount of 45 to 70% by volume, the remainder being formed by the binder composition B.

13. Feedstock according to claim 1, which is in the form of a filament or in the form of pellets.

14. Use of the feedstock as defined in claim 1 in a metal injection molding process.

15. Metal Injection Molding Process, comprising the steps
A. Injecting the feedstock as defined in claim 1 into a mold;
B. Removing the injection-molded green body from the mold;
C. Debinding the feedstock to thereby remove essentially all of the binder composition by a catalytic, thermal or chemical treatment, or a combination thereof, to obtain a Brown Body; and
D. Sintering the Brown Body.
